(19) United States
(12) Patent Application Publication
(10) Pub. No.: US 2026/0051983 A1
(43) Pub. Date: Feb. 19, 2026

(54) CONFIGURATION OF A USER EQUIPMENT FOR SINGLE-PORT TRANSMISSION

(71) Applicant: Telefonaktiebolaget LM Ericsson (publ), Stockholm (SE)

(72) Inventors: Sairamesh NAMMI, Austin, TX (US); Milad FOZOONI, Göteborg (SE)

(73) Assignee: Telefonaktiebolaget LM Ericsson (publ), Stockholm (SE)

(21) Appl. No.: 18/706,651

(22) PCT Filed: Nov. 23, 2021
(86) PCT No.: PCT/EP2021/082634

§ 371 Date: May 1, 2024

(51) Int. Cl. H04L 5/00; H04L 27/26

(52) U.S. Cl. CPC H04L 5/0044; H04L 27/261

(57) ABSTRACT

There is provided mechanisms for configuring a user equipment for single-port transmission. A method is performed by a network node. The method comprises configuring the user equipment to use single port transmission for transmitting on an uplink data channel to the network node. The method comprises transmitting RRC information towards the user equipment. The RRC information indicates a port-switching sequence that defines which sequence of ports to be used by the user equipment for consecutive transmissions of DMRS on the uplink data channel. The method comprises receiving uplink reference signals from the user equipment and uplink data and the DMRS on the uplink data channel from the user equipment.

### TECHNICAL FIELD

Embodiments presented herein relate to a method, a network node, a computer program, and a computer program product for configuring a user equipment for single-port transmission. Embodiments presented herein further relate to a method, a user equipment, a computer program, and a computer program product for single-port transmission.

### BACKGROUND

Multiple-input multiple-output (MIMO) techniques is one way to significantly increase the throughput of wireless communication systems. Therefore, MIMO techniques are an integral part of the third generation (3G) and fourth generation (4G) telecommunication standards. In fifth generation (5G) systems telecommunication standards MIMO techniques with a large number of antennas, called massive MIMO, is used. Typically, with a setup of (Nₜ, Nᵣ) antennas, where Nₜ denotes the number of transmit antennas and Nᵣ the number of receive antennas, the peak data rate scales up with a factor of Nₜ over single antenna systems in a rich scattering environment.

FIG. 1 shows a sequence diagram for a reciprocity-based communication system where MIMO techniques are used. Before the actual data transmission, the network, as represented by a network node, configures the user, as represented by a user equipment, with uplink reference signal (such as sounding reference signal; SRS) periodicity, resource configuration, downlink reference signal (such as channel state information reference signal; CSI-RS) periodicity, downlink reference signal resource configuration, channel state information (CSI) configuration, etc. using radio resource control (RRC) signalling (step 1). The user equipment transmits the uplink reference signal according to the configured periodicity and the resource configuration (step 2). The network node computes precoding weights based on the received uplink reference signal (step 3). The network node periodically transmits the downlink reference signal (step 4). The user equipment computes (step 5) the CSI, for example comprising rank indicator (RI), channel quality indicator (CQI), precoding matrix index (PMI) and layer indicator (LI) and feeds (step 6) the CSI back to the network node over an uplink control, or shared, channel. Once the network node receives the CSI, the network node uses the RI and the CQI received from the user equipment, and a PMI computed at the network node based on the received uplink reference signal to schedule the user equipment and to perform the actual data transmission (step 7).

Further, in addition to uplink and downlink reference signals, also demodulation reference signals (DMRSs) can be transmitted by the network node and the user equipment. In general terms, DMRSs are used to estimate the radio channel for demodulation. DMRSs as transmitted from the network node are device-specific, can be beamformed, and are confined in a scheduled resource. To support multiple-layer MIMO transmission, multiple orthogonal DMRS ports can be scheduled, one for each layer. FIG. 2 shows a resource block of an orthogonal frequency-division multiplexing (OFDM) symbol in time/frequency grid. The OFDM resource block is composed of resource elements (REs) spread over 12 subcarriers. In the examples of FIG. 2, a DMRS is, on a single port, transmitted on six resource elements within the OFDM symbol. OFDM transmission can be used for both downlink (DL; from the network to the user) and uplink (UL; from the user to the network) transmissions.

Some limitations of current use of DMRSs as transmitted in the uplink will be demonstrated next. Although the main example is directed to large peak amplitude values when using OFDM transmissions, there are also other network performance aspects that are impacted by limitations of current use of DMRSs as transmitted in the uplink, such as precoder determination and spatial diversity.

The transmitted signals, when using OFDM transmissions, can have high peak amplitude values in the time domain since many subcarrier components are added via an inverse fast Fourier transform (IFFT) operation. Therefore, OFDM symbols are known to have a high peak to average power ratio (PAPR) compared with single-carrier systems. The high PAPR push the transmit signal to the nonlinear region of high-power amplifiers (HPA) and imposes in-band and out-of-band distortion. This in-band and out-of-band distortion can respectively deteriorate the system performance in terms of error vector magnitude (EVM) and adjacent channel power ratio (ACPR) in the same cell as well as in neighboring cells. In fact, high PAPR is one of the most detrimental aspects of the OFDM transmission, as it decreases the signal-to-quantization noise ratio (SQNR) of analog-to-digital converters (ADC) and digital-to-analog converters (DAC) as a consequence of low efficiency of the HPAs in the transmitter.

One technique to avoid the large peak amplitude values is to use a large power back off. However, it is inefficient to run the HPAs with a large power back off and still maintain the same cell coverage. Hence, many crest factor reduction (CFR) techniques have been proposed in the literature. Clipping and filtering (CF) is a well-known conventional technique where the peaks of the time-domain signal are clipped the out-of-band emissions are filtered several times, before the transmit signal is sent through the HPAs. However, this technique still suffers from in-band emission which results in a high EVM. Thus, CF might not meet stringent EVM requirements, in particular for high modulation schemes, with a heavy clipping. FIG. 3 shows the PAPR in dB versus receiver EVM in percent (%) with the CP technique, and Table 1 shows some exemplary EVM requirements for different types of modulation (where QPSK is short for quadrature phase shift keying and QAM is short for quadrature amplitude modulation).

TABLE 1
EVM requirements as a function of modulation

| Modulation | EVM Requirement (%) |
|---|---|
| QPSK | 17.5 |
| 16 QAM | 12.5 |
| 64 QAM | 8 |
| 256 QAM | 3.5 |
| 1024 QAM | 2.5 |

It can be observed that to meet the EVM requirements, it is not possible to clip beyond a certain limit. As a result, the PAPR cannot be reduced by more than 7 dB.

Hence, techniques are needed that can help to reduce the PAPR whilst at the same time maintain the EVM requirements. Further, as noted above, there are also other network performance aspects that are impacted by limitations of current use of DMRSs as transmitted in the uplink, such as precoder determination and spatial diversity.

### SUMMARY

A general object of embodiments disclosed herein is to address the above issues and provide techniques that enable the PAPR to be reduced whilst not impacting the EVM requirements, as well as improving precoder selection and achieving spatial diversity.

In some aspects, the general object is met by the user equipment transmitting DMRSs on more than one port.

A particular object of embodiments disclosed herein is therefore to provide techniques for configuring the user equipment in an efficient way for transmission of DMRSs.

According to a first aspect there is presented a method for configuring a user equipment for single-port transmission. The method is performed by a network node. The method comprises configuring the user equipment to use single port transmission for transmitting on an uplink data channel to the network node. The method comprises transmitting RRC information towards the user equipment. The RRC information indicates a port-switching sequence that defines which sequence of ports to be used by the user equipment for consecutive transmissions of DMRS on the uplink data channel. The method comprises receiving uplink reference signals from the user equipment and uplink data and the DMRS on the uplink data channel from the user equipment.

According to a second aspect there is presented a network node for configuring a user equipment for single-port transmission. The network node comprises processing circuitry. The processing circuitry is configured to cause the network node to configure the user equipment to use single port transmission for transmitting on an uplink data channel to the network node. The processing circuitry is configured to cause the network node to transmit RRC information towards the user equipment. The RRC information indicates a port-switching sequence that defines which sequence of ports to be used by the user equipment for consecutive transmissions of DMRS on the uplink data channel. The processing circuitry is configured to cause the network node to receive uplink reference signals from the user equipment and uplink data and the DMRS on the uplink data channel from the user equipment.

According to a third aspect there is presented a network node for configuring a user equipment for single-port transmission. The network node comprises a configure module (210b) configured to configure the user equipment to use single port transmission for transmitting on an uplink data channel to the network node. The network node comprises a transmit module configured to transmit RRC information towards the user equipment. The RRC information indicates a port-switching sequence that defines which sequence of ports to be used by the user equipment for consecutive transmissions of DMRS on the uplink data channel. The network node comprises a receive module configured to receive uplink reference signals from the user equipment and uplink data and the DMRS on the uplink data channel from the user equipment.

According to a fourth aspect there is presented a computer program for configuring a user equipment for single-port transmission, the computer program comprising computer program code which, when run on processing circuitry of a network node, causes the network node to perform a method according to the first aspect.

According to a fifth aspect there is presented a method for single-port transmission. The method is performed by a user equipment. The method comprises receiving configuration from the network node for the user equipment to use single port transmission for transmitting on an uplink data channel to the network node. The method comprises receiving RRC information from the network node. The RRC information indicates a port-switching sequence that defines which sequence of ports to be used by the user equipment for consecutive transmissions of DMRS on the uplink data channel. The method comprises transmitting uplink reference signals towards the network node and uplink data and the DMRS on the uplink data channel, in accordance with the port-switching sequence, towards the network node.

According to a sixth aspect there is presented a user equipment for single-port transmission. The user equipment comprises processing circuitry. The processing circuitry is configured to cause the user equipment to receive configuration from the network node for the user equipment to use single port transmission for transmitting on an uplink data channel to the network node. The processing circuitry is configured to cause the user equipment to receive RRC information from the network node. The RRC information indicates a port-switching sequence that defines which sequence of ports to be used by the user equipment for consecutive transmissions of DMRS on the uplink data channel. The processing circuitry is configured to cause the user equipment to transmit uplink reference signals towards the network node and uplink data and the DMRS on the uplink data channel, in accordance with the port-switching sequence, towards the network node.

According to a seventh aspect there is presented a user equipment for single-port transmission. The user equipment comprises a receive module configured to receive configuration from the network node for the user equipment to use single port transmission for transmitting on an uplink data channel to the network node. The user equipment comprises a receive module configured to receive RRC information from the network node. The RRC information indicates a port-switching sequence that defines which sequence of ports to be used by the user equipment for consecutive transmissions of DMRS on the uplink data channel. The user equipment comprises a transmit module configured to transmit uplink reference signals towards the network node and uplink data and the DMRS on the uplink data channel, in accordance with the port-switching sequence, towards the network node.

According to an eighth aspect there is presented a computer program for single-port transmission, the computer program comprising computer program code which, when run on processing circuitry of a user equipment, causes the user equipment to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide efficient configuration of the user equipment for transmission of DMRSs.

Advantageously, these aspects enable the user equipment to be configured with a port-switching sequence without the need for signalling over a downlink control channel.

Advantageously, these aspects can be used for techniques that enable the PAPR to be reduced whilst not impacting the EVM requirements, as well as for techniques that improve precoder selection and achieve spatial diversity.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a signalling diagram according to an example;

FIG. 2 is a schematic illustration of one RB of an OFDM symbol according to an example;

FIG. 3 is a schematic illustration of PAPR versus receiver EVM according to an example;

FIG. 4 is a schematic diagram illustrating a wireless communication network according to embodiments;

FIG. 5 is a block diagram of a network node according to embodiments;

FIGS. 6 and 7 are flowcharts of methods according to embodiments;

FIG. 8 shows simulation results in terms of PAPR as a function of number of iterations according to embodiments;

FIG. 9 is a schematic diagram showing functional units of a network node according to an embodiment;

FIG. 10 is a schematic diagram showing functional modules of a network node according to an embodiment;

FIG. 11 is a schematic diagram showing functional units of a user equipment according to an embodiment;

FIG. 12 is a schematic diagram showing functional modules of a user equipment according to an embodiment; and

FIG. 13 shows one example of a computer program product comprising computer readable means according to an embodiment.

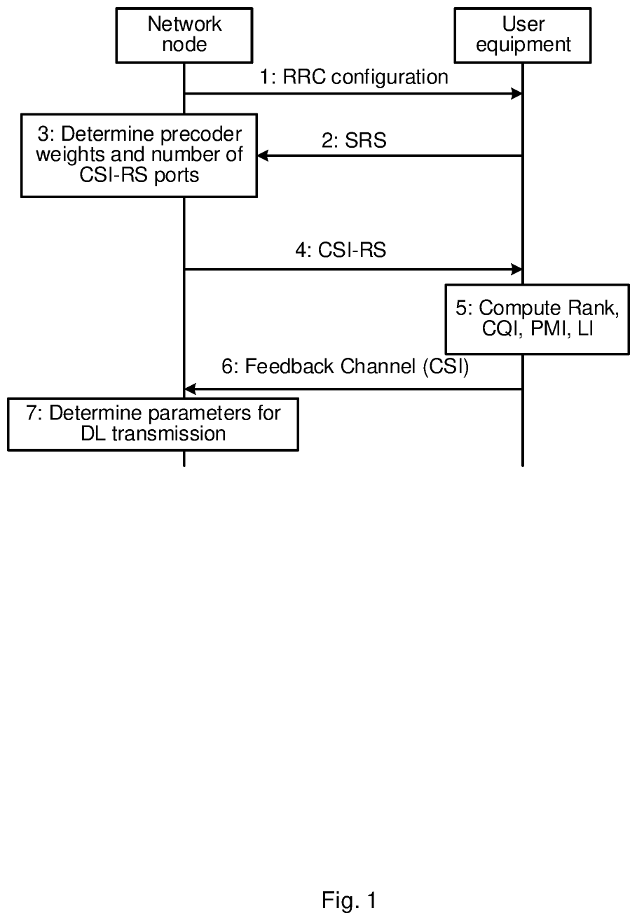

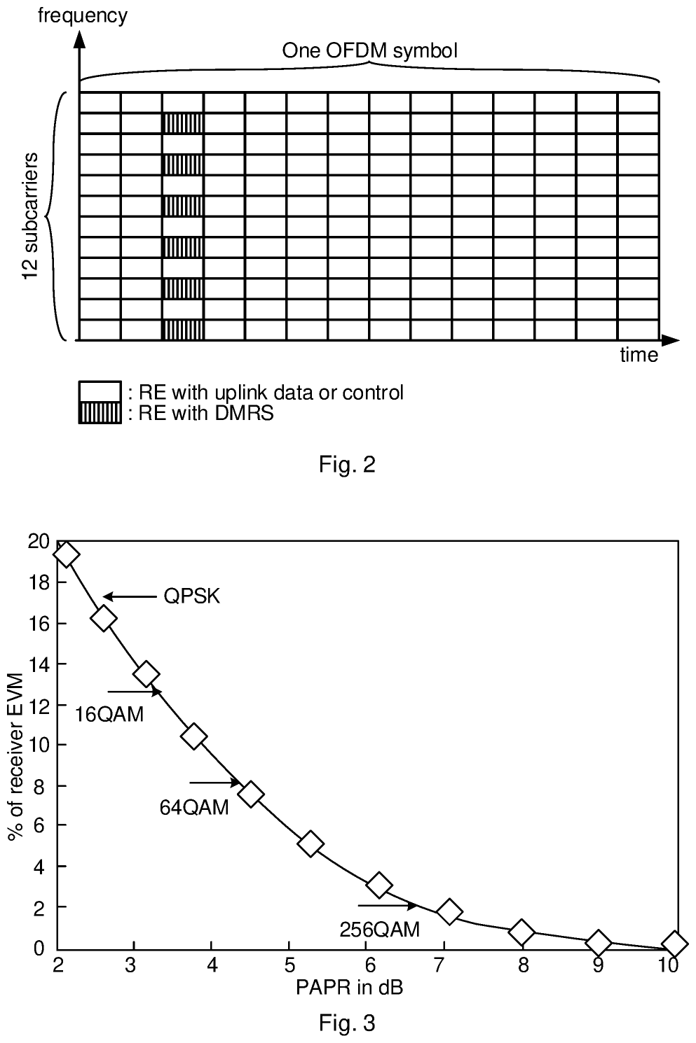

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The embodiments disclosed herein relate to mechanisms for a network node 200 to configure a user equipment 300 for single-port transmission and for a user equipment 300 to perform such single-port transmission. In order to obtain such mechanisms there is provided a network node 200, a method performed by the network node 200, a computer program product comprising code, for example in the form of a computer program, that when run on processing circuitry of the network node 200, causes the network node 200 to perform the method. In order to obtain such mechanisms there is further provided a user equipment 300, a method performed by the user equipment 300, and a computer program product comprising code, for example in the form of a computer program, that when run on processing circuitry of the user equipment 300, causes the user equipment 300 to perform the method.

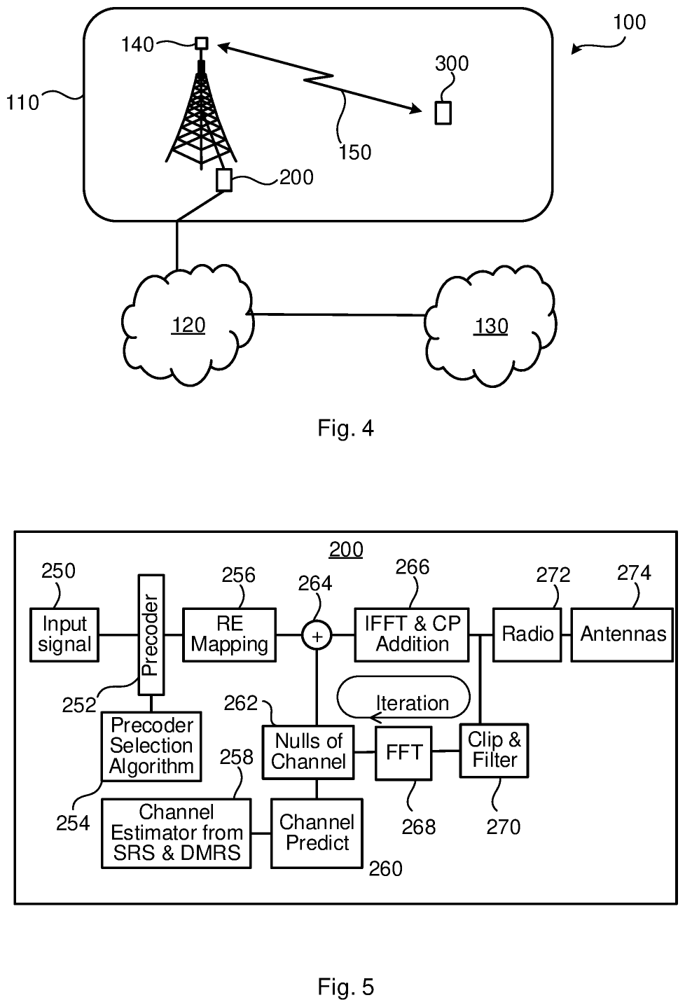

FIG. 4 is a schematic diagram illustrating an example wireless communication network 100 where embodiments presented herein can be applied. The wireless communication network 100 could be a third generation (3G) telecommunications network, a fourth generation (4G) telecommunications network, a fifth generation (5G) telecommunications network, or any evolvement thereof, and support any 3GPP telecommunications standard, where applicable. The wireless communication network 100 could alternatively be a non-cellular and/or a non-3GPP network, such as an IEEE 802.11 communications network, or any other wireless IEEE compliant communications network. The communication wireless network 100 comprises a network node 200 provided in a (radio) access network 110. The network node 200 is configured to, via a transmission and reception point 140, provide network access to user equipment 300 over a radio propagation channel 150. The (radio) access network 110 is operatively connected to a core network 120. The core network 120 is in turn operatively connected to a service network 130, such as the Internet. The user equipment 300 is thereby enabled to, via the network node 200 and its transmission and reception point 140, access services of, and exchange data with, the service network 130. Examples of network nodes 200 are radio access network nodes, radio base stations, base transceiver stations, Node Bs, evolved Node Bs, gNBs, access points, and integrated access and backhaul nodes. Examples of user equipment 300 are wireless devices, mobile stations, mobile phones, handsets, wireless local loop phones, smartphones, laptop computers, tablet computers, network equipped sensors, network equipped vehicles, and so-called Internet of Things devices.

A block diagram of a network node 200 is shown in FIG. 5. A signal block 250 provides symbols to be transmitted. The symbols are precoded by a precoder block 252 according to a precoder algorithm selected by a precoder selection algorithm block 254. In a RE mapping block, the symbols are mapped to REs. A channel estimator block 258 provides a channel estimate of the radio propagation channel 150 to a channel predictor block 260. The channel estimate might be obtained from a CSI report or utilizing reciprocity-based techniques. A channel null block 262 determines a null space estimate of the radio propagation channel 150 from received uplink reference signals and received DMRS. An IFFT is applied and a cyclic prefix (CP) is added to the signal by an IFFT and CP addition block 266. After precoding and application of the IFFT and CP addition block 266, the signal goes through a clip and filter block 270 to lower the PAPR and remove out-of-band distortion, and then an FFT is applied at an FFT block 268. However, clipping introduces in-band error distortion. This in-band error distortion defines an error signal and is projected into the null space, as given by the null space estimate, of the radio propagation channel 150, e.g., using beamforming. The beamformed error signal is together with the input signal used as input to an adder block 264 and then converted to radio frequency by a radio block 272. Finally, the signal is transmitted from an antenna block 274 comprising one or more antenna arrays.

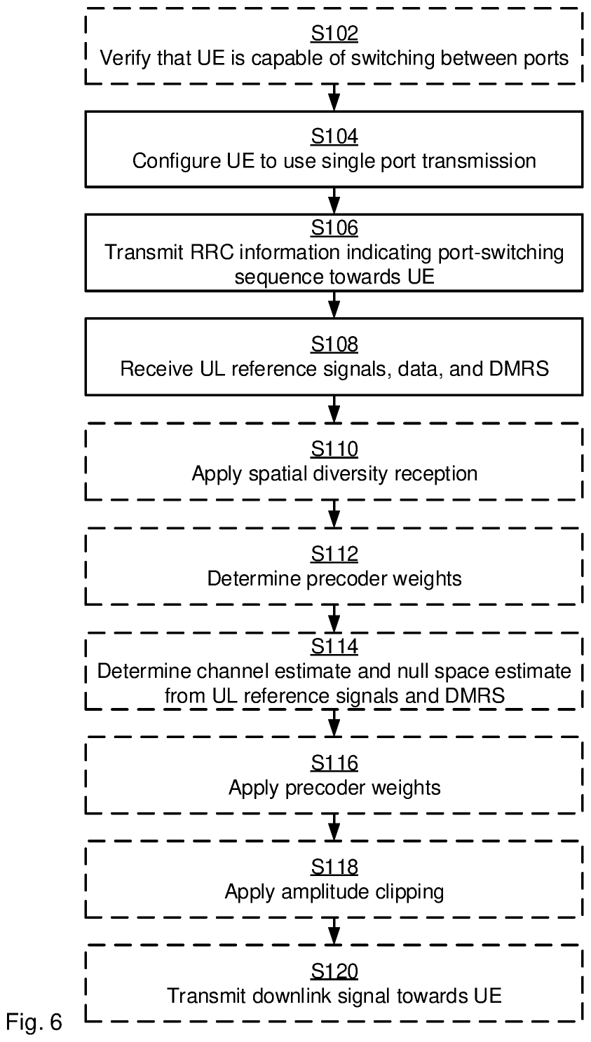

Reference is now made to FIG. 6 illustrating a method for configuring a user equipment 300 for single-port transmission as performed by the network node 200 according to an embodiment.
S104: The network node 200 configures the user equipment 300 to use single port transmission for transmitting on an uplink data channel to the network node 200.
S106: The network node 200 transmits RRC information towards the user equipment 300. The RRC information indicates a port-switching sequence. The port-switching sequence defines which sequence of ports to be used by the user equipment 300 for consecutive transmissions of DMRS on the uplink data channel.
S108: The network node 200 receives uplink reference signals from the user equipment 300. The network node 200 further receives uplink data and the DMRS on the uplink data channel from the user equipment 300. The uplink data and the DMRS has by the user equipment 300 been transmitted in accordance with the port-switching sequence.

By the network node 200 indicating the port-switching sequence utilizing RRC signalling, dynamic signaling from the network node 200 towards the user equipment 300 as part of the downlink control channel is avoided. Thus, the network node 200 can utilize resources dedicated to the downlink control channel for other purposes.

Embodiments relating to further details of configuring a user equipment 300 for single-port transmission as performed by the network node 200 will now be disclosed.

In some aspects, the network node 200 obtains information whether the user equipment 300 is capable of transmitting on different antenna ports for uplink data transmission. In particular, in some embodiments, the network node 200 is configured to perform (optional) step S102:

S102: The network node 200 verifies that the user equipment 300 is configurable to selectively switch transmission on the uplink data channel between at least two ports.

Aspects of the RRC information that indicates the port-switching sequence will be disclosed next. In general terms, the port-switching sequence might be device-specific or cell-specif. That is, in some examples, all user equipment 300 served by the network node 200 are configured with their own port-switching sequence, whereas in other examples, all user equipment 300 served by the network node 200 are configured with one and the same port-switching sequence.

In some embodiments, the RRC information comprises a binary value that indicates to the user equipment 300 to enable consecutive transmissions of DMRS on the uplink data channel in accordance with the port-switching sequence. For example, the user equipment 300 is to enable consecutive transmissions of DMRS on the uplink data channel with the port-switching sequence only when a bit dedicated in the RRC information is set to binary one. In some embodiments, the RRC information comprises the port-switching sequence itself. The network node 200 then explicitly notifies the user equipment 300 what port-switching sequence is to be used. However, in other embodiments, the RRC information comprises an index to a port-switching sequence in a set of preconfigured port-switching sequences. This could be the case where the user equipment 300 already is preconfigured with a set of different port-switching sequences, and where one of these different port-switching sequences is selected by the network node 200 for the user equipment 300 to use. An example of RRC information for port-switching with three different port-switching sequences is provided in Table 1.

TABLE 1
Example RRC information for port-switching

| RRC information | Value |
|---|---|
| Port-switching | “0” (disabled) or “1” (enabled) |
| enabling | |
| Port-switching | {0, 1, 2, 3}, {0, 3, 2, 1}, {1, 0, 3, 2}, |
| sequence | {0, 1, 0, 1}, {1, 2, 2, 3} . . . |

For example, if the network node 200 specifies the port-switching sequence {0,1,2,3}, then the user equipment 300 uses port 0 for the first transmission of the DMRS on the uplink data channel, port 1 for the second transmission of the DMRS on the uplink data channel, port 2 for the third transmission of the DMRS on the uplink data channel, and finally port 3 for the fourth transmission of the DMRS on the uplink data channel.

In some aspects, the port-switching sequences are to be cyclically used by the user equipment 300. Hence, in some embodiments, the RRC information indicates that the sequence of ports defined by the port-switching sequence is to be cyclically used by the user equipment 300 when transmitting on the uplink data channel to the network node 200. This can be used to reduce the length of the port-switching sequences. For example, if the user equipment 300 is to use the example port-switching sequence {0,1,2,3} for seven transmission occasions, the order in which the ports are to be used would be: 0, 1, 2, 3, 0, 1, 2, i.e., after having used port 3 for the fourth transmission, the user equipment 300 is to again use port 0 for the fifth transmission.

There could be different ways for the network node 200 to utilize the uplink reference signals uplink data and the DMRS received from the user equipment 300.

In some aspects, the uplink reference signals and the DMRS received from the user equipment 300 are utilized for spatial diversity purposes. Particularly, in some embodiments, the network node 200 is configured to perform (optional) step S110:

S110: The network node 200 applies spatial diversity reception by combining the DMRS as received on the uplink data channel from the user equipment 300 that according to the RRC information has been sent from the user equipment 300 on mutually different ports at different points in time.

For example, such a method could provide additional diversity in uplink data transmission which utilizes hybrid automatic repeat request (hybrid ARQ or HARQ). For example, assuming that the user equipment 300 transmits data in a transport block using port 0, and a cyclic redundancy check (CRC) check fails at the network node 200 for this transport block. The network node 200 therefore requests the user equipment 300 to retransmit the data. The user equipment 300 then retransmits the transport block using another port (as dictated by the port-switching sequence). The network node 200 can then combine the data from both transmissions and the new transmission. Since the retransmission is made from another port, the retransmission will be experience different radio conditions than the first transmission. Hence, this scheme provides spatial diversity in addition to time diversity.

In some aspects, the uplink reference signals and the DMRS received from the user equipment 300 are utilized for determining a precoder. Particularly, in some embodiments, the network node 200 is configured to perform (optional) step S112:

S112: The network node 200 determines precoder weights to be applied by the network node 200 to a downlink signal carrying downlink data towards the user equipment 300. The precoder weights are determined from the received uplink reference signals and the received DMRS.

Determining the precoder weights from the received uplink reference signals and the received DMRS will improve the channel estimation quality and facilitates in identifying a better precoder.

In some aspects, the uplink reference signals and the DMRS received from the user equipment 300 are utilized for estimating the radio propagation channel 150 over which the user equipment 300 is served by the network node 200. The received DMRS and the received uplink reference signals might further be utilized by the network node 200 for estimating the null space of the radio propagation channel 150.

Particularly, in some embodiments, the network node 200 is configured to perform (optional) step S114:

S114: The network node 200 determines a channel estimate of the radio propagation channel 150 over which the user equipment 300 is served by the network node 200 from the received uplink reference signals and the received DMRS. The network node 200 further determines a null space estimate of the radio propagation channel 150, from the received uplink reference signals and the received DMRS.

Aspects of how the network node 200 might determine the null space estimate of the radio propagation channel 150 from the received uplink reference signals and the received DMRS will be disclosed next.

The channel estimate as estimated from the uplink reference signal and the DMRS might be outdated at the time of subsequent data transmission from the network node 200. Therefore, when the error is projected onto the null space, some portion of the residual error remains as the estimated null space is not completely orthogonal to the actual channel. To mitigate this, in some examples, the null space estimate is determined as a function of a channel prediction of the radio propagation channel 150, where the channel prediction is a function of the channel estimate. Channel prediction can be used to predict future channel states from current and past channel observations. Once the radio propagation channel is predicted, the null space estimate can be determined as:

$${P}_{N} = I - {H}_{pred}^{+} {H}_{pred} ,$$

where P_{N} is a mapping to the null space, I is an identity matrix, H_{pred} is the channel prediction and

$${H}_{pred}^{+}$$

is a pseudoinverse of the channel prediction. P_{N} can thus be regarded as the orthogonal projection matrix onto the null space of the channel prediction H_{pred}. In some examples, the matrix

$${H}_{pred}^{+}$$

is the Moore-Penrose inverse of the channel prediction.

The channel prediction can be based on scheduling delay values, speed of travel of the user equipment 150, measurements on uplink reference signals, etc. In some examples, the channel prediction further is determined as a function of a weight matrix with weight values. In some examples, the channel prediction is determined as:

$${H}_{pred} = {\sum }_{m = 0}^{M - 1} {W}_{m} {H}_{est} ,$$

where H_{pred} is the channel prediction, Wₘ is the weight matrix with weight values, Hₑₛₜ is the channel estimate, and M is number of taps invoked to predict the radio propagation channel 150.

In some examples, the weight values of the weight matrix depend on an estimated speed of travel of the user equipment 300. The weight matrix might be computed based on the minimum mean square error (MMSE) or recursive least squares (RLS) or normalized linear mean square (NLMS) criteria.

In some aspects, the number of taps invoked to predict the channel depends on the user speed. That is, in some examples, the number of taps depends on a scheduling delay for the user equipment 300 or an estimated speed of travel of the user equipment 300. In some examples, the value of M depends on the scheduling delay. For example, the value of M might be linearly or non-linearly proportional to the scheduling delay.

There could be different uses of the determined null space estimate of the radio propagation channel 150. In some aspects, once the null space has been estimated (by the null space estimate being determined), the network node 200 uses clipping and filtering to clip and filter the baseband time-domain signal to a desired PAPR level and puts the error signal in the null space. This will reduce the EVM. Hence, in some aspects the network node 200 utilizes the determined null space estimate when transmitting downlink signals. Details of an example relating to such transmission of downlink signals will now be disclosed. In general terms, precoding and clipping is applied to a downlink signal to be transmitted. The clipping distortion is then hidden by being transmitted in the null space. Particularly, in some embodiments, the network node 200 is configured to perform (optional) steps S116, S118, and S120:
S116: The network node 200 applies precoder weights to a downlink signal carrying downlink data towards the user equipment 300.
S118: The network node 200 applies amplitude clipping to the downlink signal. The amplitude clipping yields an in-band error signal.
S120: The network node 200 transmits the downlink signal. The in-band error signal is subtracted from the downlink signal and transmitted in a null space given by the null space estimate.

In some embodiments, the precoder weights are determined as a function of channel state information received from the user equipment 300, the uplink reference signals, and/or the DMRS.

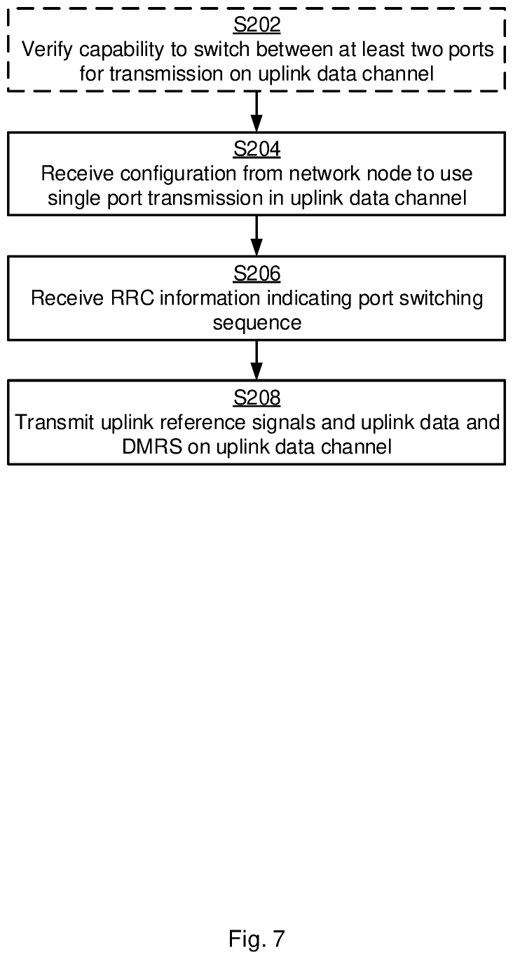

Reference is now made to FIG. 7 illustrating a method for single-port transmission as performed by the user equipment 300 according to an embodiment.
S204: The user equipment 300 receives configuration from the network node 200 for the user equipment 300 to use single port transmission for transmitting on an uplink data channel to the network node 200.
S206: The user equipment 300 receives RRC information from the network node 200. The RRC information indicates a port-switching sequence that defines which sequence of ports to be used by the user equipment 300 for consecutive transmissions of DMRS on the uplink data channel.
S208: The user equipment 300 transmits uplink reference signals towards the network node 200. The user equipment 300 further transmits uplink data and the DMRS on the uplink data channel, in accordance with the port-switching sequence, towards the network node 200.

Embodiments relating to further details of single-port transmission as performed by the user equipment 300 will now be disclosed.

As disclosed above, the network node 200 might verify that the user equipment 300 is configurable to switch the transmit on the uplink data channel between at least two ports. Hence, in some embodiments, the user equipment 300 is configured to perform (optional) step S202:
S202: The user equipment 300 verifies to the network node 200 that the user equipment 300 is configurable to switch the transmission on the uplink data channel between at least two ports.

As disclosed above, in some embodiments, the RRC information comprises a binary value that indicates to the user equipment 300 to enable consecutive transmissions of DMRS on the uplink data channel in accordance with the port-switching sequence.

As disclosed above, in some embodiments, the RRC information comprises the port-switching sequence itself.

As disclosed above, in some embodiments, the RRC information comprises an index to a port-switching sequence in a set of preconfigured port-switching sequences.

As disclosed above, in some embodiments, the RRC information indicates that the sequence of ports defined by the port-switching sequence is to be cyclically used by the user equipment 300 when transmitting on the uplink data channel to the network node 200.

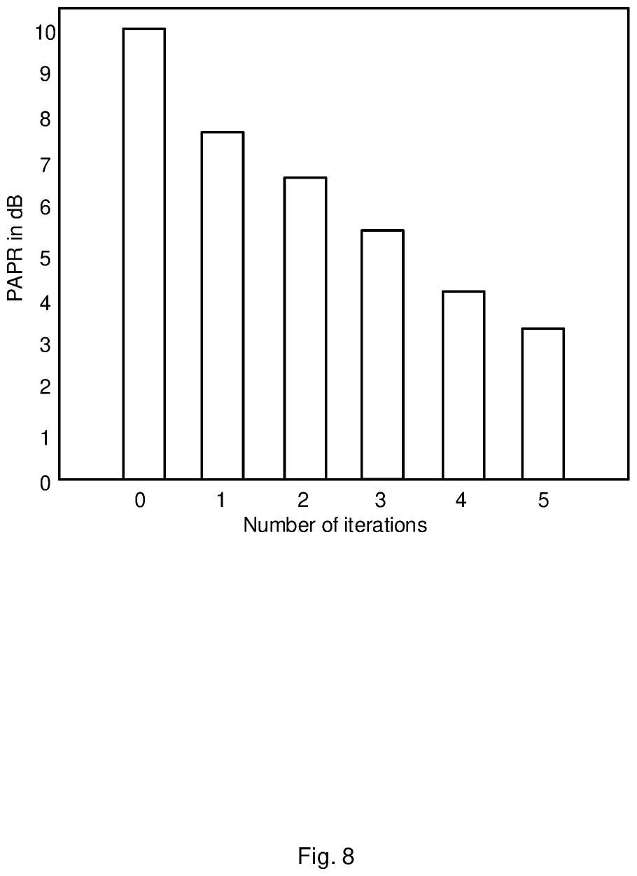

Simulation results will be disclosed next. FIG. 8 shows simulation results in terms of PAPR as a function of number of iterations according to embodiments where both uplink reference signals and DMRS are used when determining the null space estimates. Table 2 lists simulation parameters. Table 3 shows the EVM at each of the iterations in FIG. 8 and Table 4 shows the PAPR versus EVM for each listed modulation. The EVM satisfies the EVM requirements in Table 1 whilst the PAPR at the same time being significantly reduced.

TABLE 2
List of simulation parameters

| Assumptions | Value | |
|---|---|---|
| Carrier frequency | 3.5 | GHz |
| Duplex mode | Time-division duplex (TDD) | |
| System Bandwidth | 10 | MHz |
| Slot length | 1 ms (14 OFDM symbols) | |
| Subcarrier spacing | 15 | kHz |
| Guard time interval | 4.7 | μs |
| FFT size | 2048 | |
| Data transmission | 52 physical resource | |
| bandwidth | blocks (PRBs) | |
| Antenna configuration | TRP with 32 antenna elements, | |
| | user equipment with 4 | |
| | receiving antennas | |
| Number of CSI-RS ports | 32 | |
| Channel encoder | New radio low-density parity.- | |
| | check (NR-LDPC) code | |
| Modulation and coding | For link adaptation: QPSK, 16-QAM, | |
| scheme (MCS) | 64-QAM 256 QAM are considered | |
| | with variable code rate | |
| Control Overhead | 2 OFDM symbols | |
| Channel estimation | Practical channel estimation | |
| Channel model | CDL -A cross pole | |
| UE speed | 3 | km/h |
| DMRS configuration | Type 1 configuration with frontloaded | |
| | on third OFDM symbol with | |
| | one additional DMRS | |
| Feedback delay | 4 | slots |

TABLE 3
EVM for each iteration

| Number of Iterations | EVM (%) |
|---|---|
| 1 | 0.0055 |
| 2 | 0.0094 |
| 3 | 0.0139 |
| 4 | 0.0184 |
| 5 | 0.023 |

TABLE 4
PAPR and EVM for each modulation after 5 iterations

| Modulation | PAPR (dB) | EVM (%) |
|---|---|---|
| QPSK | 3.45 | 0.02 |
| 16 QAM | 3.43 | 0.02 |
| 64 QAM | 3.46 | 0.02 |
| 256 QAM | 3.37 | 0.02 |

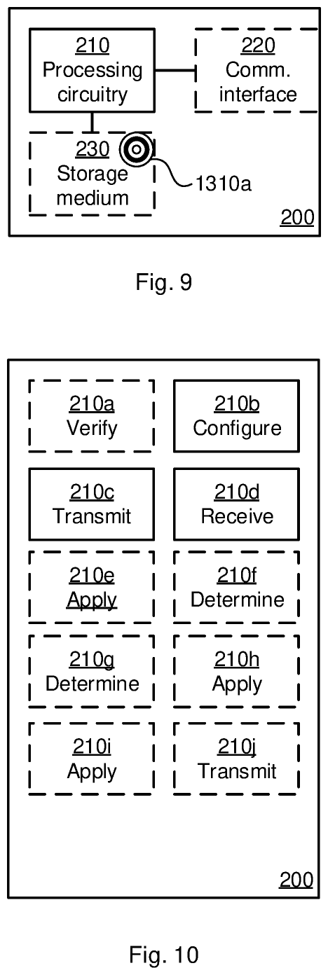

FIG. 9 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1310a (as in FIG. 13), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications interface 220 for communications with other entities, functions, nodes, and devices. As such the communications interface 220 may comprise one or more transmitters and receivers, comprising analogue and digital components.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 10 schematically illustrates, in terms of a number of functional modules, the components of a network node 200 according to an embodiment. The network node 200 of FIG. 10 comprises a number of functional modules; a configure module 210b configured to perform step S104, a transmit module 210c configured to perform step S106, and a receive module 210d configured to perform step S108. The network node 200 of FIG. 10 may further comprise a number of optional functional modules, such as any of a verify module 210a configured to perform step S102, an apply module 210e configured to perform step S110, a determine module 210f configured to perform step S112, a determine module 210g configured to perform step S114, an apply module 210h configured to perform step S116, an apply module 210i configured to perform step S118, and a transmit module 210j configured to perform step S120. In general terms, each functional module 210a:210j may be implemented in hardware or in software. Preferably, one or more or all functional modules 210a:210j may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210j and to execute these instructions, thereby performing any steps of the network node 200 as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 9 the processing circuitry 210 may be distributed among a plurality of devices, or nodes. The same applies to the functional modules 210a:210j of FIG. 10 and the computer program 1320a of FIG. 13.

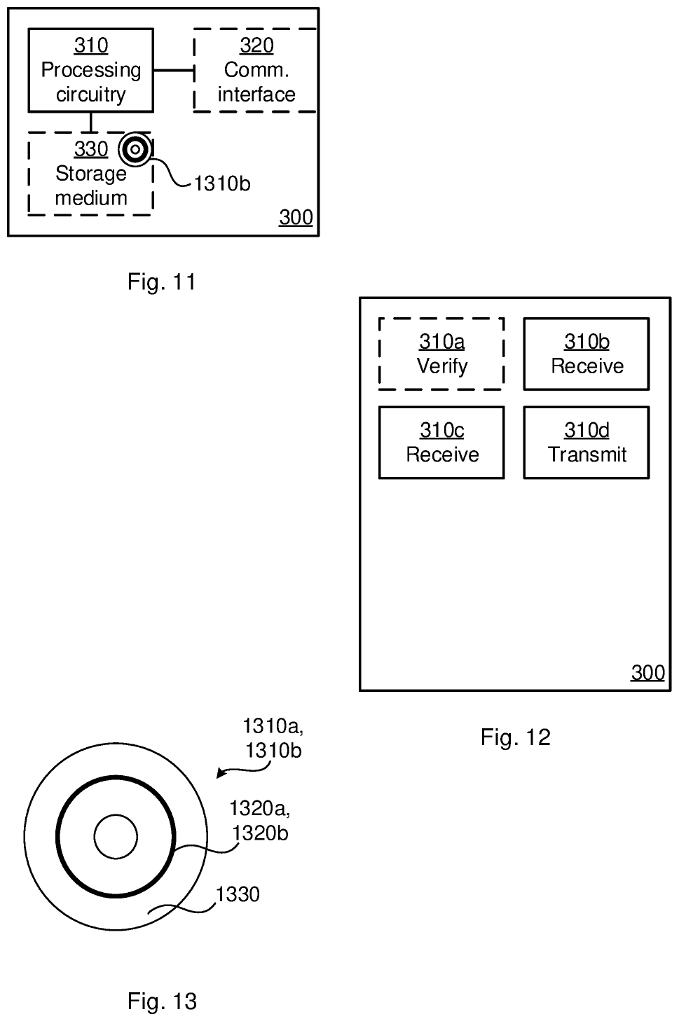

FIG. 11 schematically illustrates, in terms of a number of functional units, the components of a user equipment 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1310b (as in FIG. 13), e.g. in the form of a storage medium 330. The processing circuitry 310 may further be provided as at least one application specific integrated circuit (ASIC), or field programmable gate array (FPGA).

Particularly, the processing circuitry 310 is configured to cause the user equipment 300 to perform a set of operations, or steps, as disclosed above. For example, the storage medium 330 may store the set of operations, and the processing circuitry 310 may be configured to retrieve the set of operations from the storage medium 330 to cause the user equipment 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The user equipment 300 may further comprise a communications interface 320 for communications with other entities, functions, nodes, and devices. As such the communications interface 320 may comprise one or more transmitters and receivers, comprising analogue and digital components.

The processing circuitry 310 controls the general operation of the user equipment 300 e.g. by sending data and control signals to the communications interface 320 and the storage medium 330, by receiving data and reports from the communications interface 320, and by retrieving data and instructions from the storage medium 330. Other components, as well as the related functionality, of the user equipment 300 are omitted in order not to obscure the concepts presented herein.

FIG. 12 schematically illustrates, in terms of a number of functional modules, the components of a user equipment 300 according to an embodiment. The user equipment 300 of FIG. 12 comprises a number of functional modules; a receive module 310b configured to perform step S204, a receive module 310c configured to perform step S206, and a transmit module 310d configured to perform step S208. The user equipment 300 of FIG. 12 may further comprise a number of optional functional modules, such as a verify module 310a configured to perform step S202. In general terms, each functional module 310a:310d may be implemented in hardware or in software. Preferably, one or more or all functional modules 310a:310d may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310d and to execute these instructions, thereby performing any steps of the user equipment 300 as disclosed herein.

FIG. 13 shows one example of a computer program product 1310a, 1310b comprising computer readable means 1330. On this computer readable means 1330, a computer program 1320a can be stored, which computer program 1320a can cause the processing circuitry 210 and thereto operatively coupled entities and devices, such as the communications interface 220 and the storage medium 230, to execute methods according to embodiments described herein. The computer program 1320a and/or computer program product 1310a may thus provide means for performing any steps of the network node 200 as herein disclosed. On this computer readable means 1330, a computer program 1320b can be stored, which computer program 1320b can cause the processing circuitry 310 and thereto operatively coupled entities and devices, such as the communications interface 320 and the storage medium 330, to execute methods according to embodiments described herein. The computer program 1320b and/or computer program product 1310b may thus provide means for performing any steps of the user equipment 300 as herein disclosed.

In the example of FIG. 13, the computer program product 1310a, 1310b is illustrated as an optical disc, such as a CD (compact disc) or a DVD (digital versatile disc) or a Blu-Ray disc. The computer program product 1310a, 1310b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320a, 1320b is here schematically shown as a track on the depicted optical disk, the computer program 1320a, 1320b can be stored in any way which is suitable for the computer program product 1310a, 1310b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for configuring a user equipment for single-port transmission, the method being performed by a network node, the method comprising:
configuring the user equipment to use single port transmission for transmitting on an uplink data channel to the network node;
transmitting radio resource control, RRC, information towards the user equipment, wherein the RRC information indicates a port-switching sequence that defines which sequence of ports to be used by the user equipment for consecutive transmissions of demodulation reference signal, DMRS, on the uplink data channel; and
receiving uplink reference signals from the user equipment and uplink data and the DMRS on the uplink data channel from the user equipment.

2. The method according to claim 1, wherein the method further comprises:
verifying that the user equipment is configurable to selectively switch transmission on the uplink data channel between at least two ports.

3. The method according to claim 1, wherein the RRC information comprises a binary value that indicates to the user equipment to enable consecutive transmissions of DMRS on the uplink data channel in accordance with the port-switching sequence.

4. The method according to claim 1, wherein the RRC information comprises the port-switching sequence itself.

5. The method according to claim 1, wherein the RRC information comprises an index to a port-switching sequence in a set of preconfigured port-switching sequences.

6. The method according to claim 1, wherein the RRC information indicates that the sequence of ports defined by the port-switching sequence is to be cyclically used by the user equipment when transmitting on the uplink data channel to the network node.

7. The method according to claim 1, wherein the method further comprises:
applying spatial diversity reception by combining the DMRS as received on the uplink data channel from the user equipment that according to the RRC information has been sent from the user equipment on mutually different ports at different points in time.

8. The method according to claim 1, wherein the method further comprises:
determining precoder weights to be applied by the network node to a downlink signal carrying downlink data towards the user equipment, from the received uplink reference signals and the received DMRS.

9. The method according to claim 1, wherein the method further comprises:
determining a channel estimate of a radio propagation channel over which the user equipment is served by the network node, and a null space estimate of the radio propagation channel, from the received uplink reference signals and the received DMRS.

10. The method according to claim 9, wherein the null space estimate is determined as a function of a channel prediction of the radio propagation channel, where the channel prediction is a function of the channel estimate.

11. The method according to claim 10, wherein the null space estimate is determined as:
$${P}_{N} = I - {H}_{pred}^{+} {H}_{pred}$$
where P_{N} is a mapping to the null space, I is an identity matrix, H_{pred} is the channel prediction and
$${H}_{pred}^{+}$$
is a pseudoinverse of the channel prediction.

12. The method according to claim 9, wherein the method further comprises:
applying precoder weights to a downlink signal carrying downlink data towards the user equipment;
applying amplitude clipping to the downlink signal, the amplitude clipping yielding an in-band error signal; and
transmitting the downlink signal, wherein the in-band error signal is subtracted from the downlink signal and transmitted in a null space given by the null space estimate.

13. The method according to claim 12, wherein the precoder weights are determined as a function of channel state information received from the user equipment, the uplink reference signals, and/or the DMRS.

14. A method for single-port transmission, the method being performed by a user equipment, the method comprising:
receiving configuration from the network node for the user equipment to use single port transmission for transmitting on an uplink data channel to the network node;
receiving radio resource control, RRC, information from the network node, wherein the RRC information indicates a port-switching sequence that defines which sequence of ports to be used by the user equipment for consecutive transmissions of demodulation reference signal, DMRS, on the uplink data channel; and
transmitting uplink reference signals towards the network node and uplink data and the DMRS on the uplink data channel, in accordance with the port-switching sequence, towards the network node.

15. The method according to claim 14, wherein the method further comprises:
verifying to the network node that the user equipment is configurable to switch the transmission on the uplink data channel between at least two ports.

16.-19. (canceled)

20. A network node for configuring a user equipment for single-port transmission, the network node comprising processing circuitry, the processing circuitry being configured to cause the network node to:
configure the user equipment to use single port transmission for transmitting on an uplink data channel to the network node;
transmit radio resource control, RRC, information towards the user equipment, wherein the RRC information indicates a port-switching sequence that defines which sequence of ports to be used by the user equipment for consecutive transmissions of DMRS on the uplink data channel; and
receive uplink reference signals from the user equipment and uplink data and the DMRS on the uplink data channel from the user equipment.

21.-22. (canceled)

23. A user equipment for single-port transmission, the user equipment comprising processing circuitry, the processing circuitry being configured to cause the user equipment to:
receive configuration from the network node for the user equipment to use single port transmission for transmitting on an uplink data channel to the network node;
receive radio resource control, RRC, information from the network node, wherein the RRC information indicates a port-switching sequence that defines which sequence of ports to be used by the user equipment for consecutive transmissions of DMRS on the uplink data channel;
transmit uplink reference signals towards the network node and uplink data and the DMRS on the uplink data channel, in accordance with the port-switching sequence, towards the network node.

24.-27. (canceled)

28. A computer program product comprising a non-transitory computer readable medium storing a computer program comprising instructions which, when executed on processing circuitry, cause the processing circuitry to carry out the method according to claim 1.

29. A computer program product comprising a non-transitory computer readable medium storing a computer program comprising instructions which, when executed on processing circuitry, cause the processing circuitry to carry out the method according to claim 14.
